(19) United States
(12) Patent Application Publication
(10) Pub. No.: US 2026/0081502 A1
(43) Pub. Date: Mar. 19, 2026

(54) Over-Running Shaft Core Assembly for a Rotating Machine

(71) Applicant: C.E. Niehoff & Co., Evanston, IL (US)

(72) Inventor: Lukasz Wyderski, Frankin Park, IL (US)

(73) Assignee: C.E. Niehoff & Co., Evanston, IL (US)

(21) Appl. No.: 18/890,233

(22) Filed: Sep. 19, 2024

(51) Int. Cl. H02K 7/108; F02B 63/04; F16D 47/02; F16D 47/04; F16H 7/02; H02K 7/10

(52) U.S. Cl. CPC H02K 7/108; F16D 47/02; F16D 47/04; F16H 7/02; H02K 7/1004; F02B 63/042

(57) ABSTRACT

A rotating over-running shaft core assembly described herein decouples a clutching mechanism from load effects caused by an external belt driving an electrical machine. An integrated the clutch mechanism decouples stresses applied by the external belt to contend with radial loads associated with the mass of the rotor structure Friction elements integrated into the over-running shaft core assembly and positioned to provide a friction effect to the rotating shaft reduces shock loads that may be experienced at the shaft upon clutch engagement and re-engagement, such as when oscillating through an engine revolution range.

### BACKGROUND

Rotating machines are used in many applications such as to convert mechanical energy to electrical energy and/or to convert electrical energy to mechanical energy. For example, an illustrative rotating machine may be used in a power generation application, such as an alternator or other electrical power generator for a vehicle. Vehicle alternators may be driven by a belt coupled to the vehicle's engine to facilitate electrical power generation. Often, the rotating assembly of the rotating machine often imparts large transient torque loads to the external drive mechanism whenever a speed change is required. These transient torque loads often cause accelerated wear to the drive mechanism, or in the case of a belt drive, ejection of the belt. Historically, attempts to resolve these issues often involved the use of a third-party over-running pulley fitted to the rotating shaft of the generator. However, such solutions are often cost-prohibitive and also reduce the reliability of the generator system due to the forces imparted to the clutching mechanism under regular use. For example, forces imparted to the rotating assembly often cause reduced lifespan of bearing(s) integral to the rotating machine. Bearing failures cause extended downtime of the vehicle due to the maintenance time required.

### BRIEF SUMMARY

The following presents a simplified summary of various aspects described herein. This summary is not an extensive overview, and is not intended to identify key or critical elements or to delineate the scope of the claims. The following summary merely presents some concepts in a simplified form as an introductory prelude to the more detailed description provided below.

To overcome the above-noted problems, a need has been recognized for a rotating assembly of a generator of electrical power that integrates over-running capability directly into the rotating assembly to provide a lower cost and more reliable power generation. The rotating assembly described herein decouples a clutching mechanism from load effects caused by a belt driving the electrical generator (e.g., an alternator). When integrated into the rotating assembly, the clutch mechanism only contends with radial loads associated with the mass of the core and rotor(s). As such, this decoupling dramatically reduces stresses imparted to the rolling elements (e.g., bearings) and sprags of the clutch assembly, thus extending an overall operating life. A friction effect introduced into the rotating assembly also reduces shock loads that may be experienced at the shaft of the rotating assembly upon clutch re-engagement, such as when oscillating through the engine revolution range (e.g., a rapid increase and/or decrease in engine revolutions).

The rotating assembly differs from existing clutching devices by a presence of one or more friction elements that raise a torque threshold that is required to initiate relative motion between a shaft and a core of the rotating assembly. The effect of the raised torque threshold ensures that the clutch element rides through minor torque transients and only reacts to larger engine transients, such as a rapid decrease in revolutions (e.g., rev-down) and/or shut down. As such, the rotating assembly may be unaffected by each transmission shift or minor throttle release. As such, the friction elements reduce the overall wear to the sprags in the clutch mechanism, thus significantly extending the operational life of the clutch assembly.

Further advantages of the presently described over-running shaft core assembly includes drop-in interchangeability with legacy rotating assemblies, such as by retrofitting previously manufactured alternators. Additionally, the over-running shaft core assembly has no impact on the output potential of the associated generator. For example, the bearing and clutch elements are positioned to not interfere with the magnetic flux path required for operation of a homopolar alternator. Additionally, the over-running shaft core assembly experiences no reduction in operating capability due to temperature and/or environmental conditions. Further, manufacturing processes for the over-running shaft core assembly includes negligible changes to machining processes compared to previously used solid rotating assemblies, as no additional grinding and/or heat-treatment is required as an assembly sequence may utilize a press fixture. Further, components included with the over-running shaft assembly has little impact on the overall cost of the rotor assembly and, as such is significantly less than use of existing external clutching pulleys. Indeed, the over-running shaft core assembly allows use of an inexpensive solid drive pulley. Additionally, a rotation direction for the over-running feature can be controlled by simply flipping the clutching bearing during assembly.

These features, along with many others, are discussed in greater detail below.

### BRIEF DESCRIPTION OF THE DRAWINGS

Aspects of the disclosure may be implemented in certain parts, steps, and embodiments that will be described in detail in the following description and illustrated in the accompanying drawings in which like reference numerals indicate similar elements. It will be appreciated with the benefit of this disclosure that the steps illustrated in the accompanying figures may be performed in other than the recited order and that one or more of the steps may be optional. It will also be appreciated with the benefit of this disclosure that one or more components illustrated in the accompanying figures may be positioned in other than the disclosed arrangement and that one or more of the components illustrated may be optional, in which:

FIG. 1 shows an isometric cross-sectional view of an over-running shaft core assembly according to aspects of the disclosure;

FIG. 2 shows an isometric cross-sectional view of an electrical machine with an installed over-running shaft core assembly, according to aspects of the disclosure;

FIG. 3 shows an illustration of belt tension load exposure to a generator with an integrated over-running shaft core assembly, according to aspects of the disclosure; and

FIG. 4 shows an illustrative block diagram representation of a power generation system for a vehicle, according to aspects of the disclosure; and

FIGS. 5A-5I show illustrative cross-sectional views of frictional elements that provide a frictional force to a rotating shaft, according to aspects of the disclosure.

### DETAILED DESCRIPTION

In the following description of various example structures and methods in accordance with the invention, reference is made to the accompanying drawings, which form a part hereof, and in which are shown by way of illustration various fitness devices and systems using fitness devices in accordance with various embodiments of the invention. Additionally, it is to be understood that other specific arrangements of parts and structures may be utilized and structural and functional modifications may be made without departing from the scope of the invention.

It is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof, as well as additional items and equivalents thereof. As used in this description, a set refers to a collection of one or more elements.

The over-running shaft core assembly may be designed for use in a power generator application, and may be used in other rotary applications that may be subject to transient torque loads. For example, in a power generator application, such as an alternator of a vehicle, an inertia of a rotating assembly may impart large transient torque loads to an external drive mechanism whenever a speed change is required. Such loads have been known to cause accelerated wear to the drive mechanism, or in the case of a belt drive, ejection of the belt. In some cases, an attempt to resolve this issue has historically been done through the use of a third-party over-running pulley fitted to the shaft of the generator. However, such solutions are often cost-prohibitive and also reduce the reliability of the generator system due to the forces imparted to the clutching mechanism under regular use. Thus, the over-running shaft core assembly integrates an over-running capability directly within the rotating assembly to resolve issues due to transient torque loads, without use of expensive third-party external mechanisms and provides greater reliability to ensure proper generator operation.

The over-running shaft core assembly isolates a clutching mechanism from exposure to belt tension loads. As such, the integral clutch mechanism only contends with radial loads exerted by the mass of the core and rotors of the rotating assembly. In doing so, stresses imparted to the functional elements of the clutch bearing are dramatically reduced, which extends an overall operating life of the clutching mechanism. An additional benefit is that since the extended life of the clutching mechanism means the generator remains operational longer with less downtime for the vehicle in which it is installed.

The over-running shaft core assembly also integrates a friction element array. The friction element array raises a torque threshold required to initiate relative motion between the shaft and core. The friction element array provides a static friction effect that causes the clutch to only engage or otherwise react to larger torque transients, such as a rapid engine deceleration or engine shut down. Without use of the friction element array, the clutch mechanism may experience rapid wear as it responds (e.g., engages due) to smaller torque transients, that occur more frequently and are associated with, for example, transmission shifting events and/or throttle release. Additionally, the dynamic friction effect of the frictional element array decreases clutch engagement impact loading effects by converting at least a portion of the kinetic energy of shaft-core relative motion to heat, thus extending the functional life of the system.

Another benefit provided by the over-running shaft core assembly is an ability to increase (e.g., up-size) a clutching mechanism due to additional space available within the rotating assembly. For example, currently over-running pulleys are externally mounted on an alternator shaft. As such, these overrunning pulleys are sized to fit into a compartment that is very space constrained in most applications. Thus, current over-running pulley applications are forced to use smaller clutching mechanisms. In such applications, the rolling (e.g., bearings) and clutching (e.g., sprags) elements of these smaller mechanisms are subjected to greater individual stresses under the same input torque loads as compared to the larger and more numerous elements incorporated into the over-running shaft core assembly, within the same space-constrained environment. The larger components provide an extended life and torque capacity of the over-running shaft core assembly over the available options available for these applications.

Little to no changes are made for use of the over-running shaft core assembly as the outside dimensions remains the same as present rotating assemblies. As such, the over-running shaft core assembly maintains a drop-in interchangeability with legacy rotating assemblies. Further, the over-running shaft core assembly provides no decrease in unit electrical output because the positioning of bearing and clutch elements is made to have no interfere with the magnetic flux path required for a generator to operate. Additionally, use of the over-running shaft core assembly in a power generator provides no reduction in environmental operating capability.

Time and cost for construction of the over-running shaft core assembly remains largely unchanged due to negligible machining changes when compared to legacy solid rotating assembly. The over-running shaft core assembly sequence is simple and may require use of only a press fixture. The overall use costs for a power generator with an over-running shaft core assembly are reduced when compared to the minimal impact from the updated bill of materials for the over-running shaft core assembly and the much larger costs of external clutching pulleys. Indeed, use over-running shaft core assembly permits use of an inexpensive solid drive pully. Further, a direction of the over-running feature may be configured or otherwise controlled through an orientation of the clutching bearing during assembly, where a clockwise direction may be configured through a first orientation and a counter-clockwise direction may be configured through a second orientation opposite the first orientation (e.g., a flipped installation).

While this disclosure describes in detail in terms of specific examples including presently preferred modes of carrying out the invention, those skilled in the art will appreciate that there are numerous variations and permutations of the above described systems and methods. Thus, the spirit and scope of the invention should be construed broadly as set forth in the appended claims.

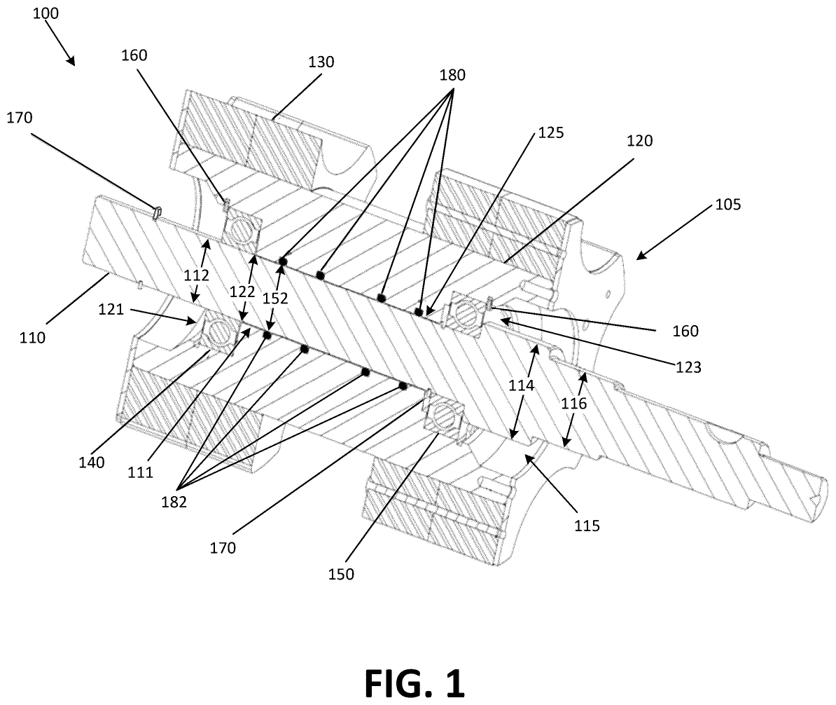

FIG. 1 shows an isometric cross-sectional view of an over-running shaft core assembly 100 according to aspects of the disclosure. While the illustrated over-running shaft core assembly is shown for a particular generator type (e.g., a homopolar generator), the over-running shaft core design may be applicable to other rotary machine configurations used in applications that use an external clutch bearing. The over-running shaft core assembly 100 may include multiple components including, for example, a shaft 110, a core 120, one or more reference rotor laminations 130, a sprag clutch bearing 140, a bearing 150, one or more outer diameter retaining rings 160, one or more inner diameter retaining rings 170, and one or more frictional elements 180. In some cases, a roller clutch may be used in place of the sprag clutch bearing 140.

In FIG. 1, the over-running shaft core assembly 100 may comprise at least two main components, a rotor assembly 105 and a shaft 110 that may pass through a through bore 115 of the core 120. The through bore 115 may be centered on an axis of rotation of the core 120. The reference rotor laminations 130 may be physically secured to the core 120 such that an inner surface of the reference rotor laminations 130 physically contacts an exterior surface of the core 120. In some cases, the core 120 may be generally cylindrical shaped and may have a through bore 115 passing through the core 120 along a central axis.

The through bore 115 of the core 120 may include a first recess 121 and a second recess 123, where the first recess 121 is located on a first side of the core 120 and the second recess 123 is located on a second side of the core 120 opposite the first recess 121. The first recess 121 and the second recess 123 may be concentric with the through bore 115. The first recess 121 may be dimensioned based on outer dimensions of the bearing 150 and the second recess 123 may be dimensioned based on outer dimensions of the sprag clutch bearing 140. For example, the first recess 121 may be sized to accommodate the outer dimensions of the bearing 150 with a defined fit (e.g., a clearance fit, a transition fit, an interference fit), where surface, hardness, and tolerance specifics may be determined based on a particular type and/or manufacturer of the bearing 150. Similarly, the second recess 123 may be sized to accommodate the outer dimensions of the sprag bearing 140 with a defined fit (e.g., a clearance fit, a transition fit, an interference fit), where surface, hardness, and tolerance specifics may be determined based on a particular type of the sprag clutch bearing 140 to be installed. A central opening of each of the sprag clutch bearing 140 and the bearing 150 are aligned concentrically with the through bore 115 when located in the first recess 121 and the second recess 123. Each of the sprag clutch bearing 140 and the bearing 150 may be retained in the first recess 121 and the second recess 123, respectively, via an outer diameter retaining ring 160 and/or an inner diameter retaining ring 170. In some cases, each outer diameter retaining ring 160 may be physically secured in an associated groove in the core 120 and each inner diameter retaining ring may be physically secured in an associated groove in the shaft 110.

The shaft 110 may be formed with one or more features having one or more different diameters. In some cases, the shaft 110 may be formed having a single diameter. In the illustrative example, the shaft 110 has been formed having multiple regions having different diameters including a first region with a first diameter 112, a second region with a second diameter 114 and the third region with a third diameter 116, where at least a portion of each of the first region, second region, and third region are within a cavity of a housing of the electrical machine in which the over-running shaft core assembly 100 is installed. In some cases, when the shaft 110 is installed in the over-running shaft core assembly 100, the first region may extend through the through bore 115 of the core 120 and may extend past an end of the core 120. In some cases, the second region may separate mechanical elements of the over-running shaft core assembly 100 from external components of an associated electrical machine, such as a bearing externally mounted as part of a stator assembly or housing assembly of the electrical machine. In some cases, the third region of the shaft 110 may have its diameter sized based on a selection of the externally mounted bearing. The shaft 110 may also include one or more regions that extend past the housing of the electrical machine (e.g., extend from within the interior cavity of the housing and through an opening in the housing), such that a driving mechanism may be physically attached to the shaft 110, such as a solid pully to facilitate a driving force applied to the shaft via a belt.

The core 120, as discussed above, includes the through bore 115 configured to receive the shaft 110 via one of the recesses (e.g., the first recess 121 or the second recess 123). In some cases, the shaft 110 may be inserted into the core 120 via the second recess 123 and extend out of the core via the first recess 121. The through bore 115 may have a diameter 122 configured to receive the shaft 110 within a specified tolerance or fit based on a first diameter 112 of the shaft 110 to allow for rotation of the shaft 110 within the through bore 115 when the sprag clutch bearing 140 is not engaged and facilitates a physical connection between the shaft 110 and the core 120 when the sprags are engaged to cause the core 120 to move with the shaft 110, such as to allow rotation of the core 120 with the shaft 110. Because the sprag clutch bearing 140 allows for rotation in one direction, the sprag clutch bearing 140 may allow the core 120 to rotate with the shaft 110 in one direction, where the direction of core rotation may be set upon installation of the sprag clutch bearing 140 within the first recess 121.

Along an interior surface 125 of the through bore 115 of the core 120 one or more grooves 182 or other retaining structures may be formed to each receive an associated frictional element of one or more static frictional elements 180. In some cases, the grooves 182 may be distributed along the interior surface 125 of the through bore. The frictional elements 180 may be an O-ring, gasket, or other structure (e.g., an injected insert) that are secured in the grooves 182 to provide a frictional force against the surface 111 of the shaft 110 as the shaft 110 freely rotates within the through bore 115. In some cases, the frictional elements may be sized such that a portion of the frictional elements 180 extend past an edge of the grooves 182 at the interior surface 125 of the core 120. The portion of the frictional elements 180 that contacts the surface 111 of the shaft 110 provide a dynamic frictional force to the shaft 110 as it rotates within the through bore 115 to allow the freewheeling core 120 to ride through and dissipate the kinetic energy of transient torque events associated with an externally applied driving force to the shaft. The frictional force provided by the frictional elements 180 causes a disengagement delay of the sprag clutch bearing 125 to avoid disengagement due to transient forces induced into the system, such as by clutching of a motor driving an alternator. In an illustrative example, the friction elements 180 may be arranged to target a decoupling torque threshold of about 10% of the steady state driving torque as a default. In some cases, the decoupling torque threshold may be defined within a range from about 0.5% of the steady state driving torque to about 25% of the steady state driving torque. In some cases, one or more friction elements can be added or removed from the assembly to achieve a customer-specified static-friction torque threshold. In some cases, the frictional elements may be formed of materials with friction and wear characteristics of or similar to those of Viton, Buna-N, Polyurethane, PTFE, Silicone-rubber, EPDM, etc.

In some cases, a width of the portion of the frictional elements 180 that extend past the interior surface 125 of the through bore 115 may be determined based on a frictional coefficient and/or a wear coefficient of the material of which the frictional elements 180 are formed. In some cases, each of the frictional elements 180 may be formed of a same material. In some cases, one or more of the frictional elements 180 may be formed from different materials. In some cases, the material (or materials) of the frictional elements 180 may be selected to maximize wear life, to meet a selected applied frictional force, and/or a combination of these or different factors.

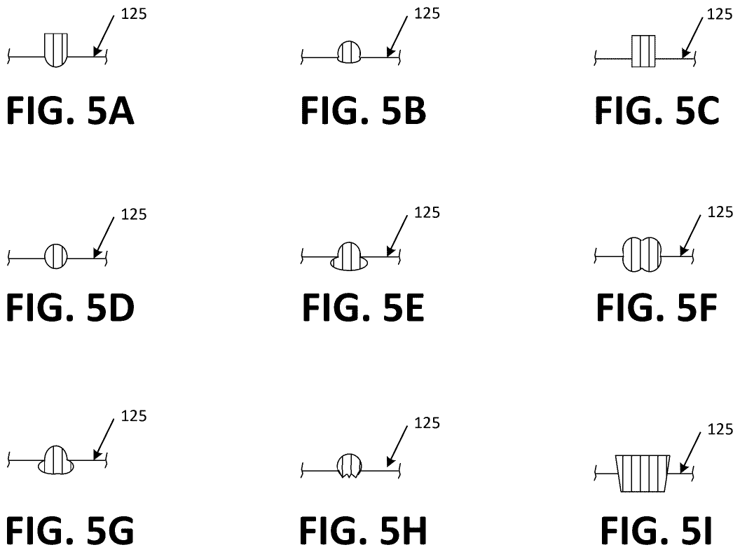

In some cases, to meet a defined frictional force threshold, one or more of the frictional elements 180 may be custom molded with dimensions and/or a cross-sectional shape that, in combination with characteristics of the material of which it is made, provides a surface area capable of providing, alone or in combination, a frictional force to the surface of the rotating shaft or another portion of the over-running shaft core assembly 100 is installed. Illustrative cross-sectional areas of frictional elements are shown in FIGS. 5A-5I. In some cases, frictional elements of different materials may be combined to provide a combination of frictional elements capable of meeting the defined decoupling torque threshold. In some cases, a frictional force threshold may be defined by a combination of frictional elements 180 having a same material and/or cross-sectional shape. In some cases, the frictional force threshold may be defined using a combination of frictional elements of different materials and/or cross-sectional shapes. To customize or otherwise change a frictional force threshold, the shaft 110 may be removed such that one or more frictional elements may be added, removed, and/or changed such that a desired frictional force threshold may be provided.

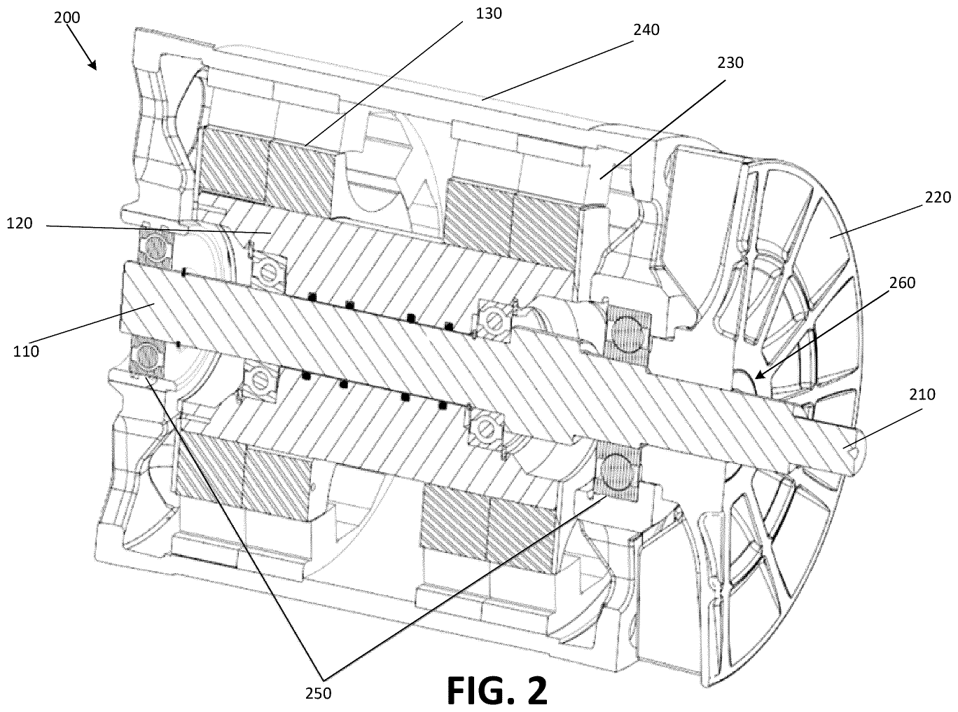

FIG. 2 shows an isometric cross-sectional view of an electrical machine 200 (e.g., a generator, an alternator, a motor, and the like) with an installed over-running shaft core assembly 100 according to aspects of the disclosure. For example, the electrical machine may be a homopolar generator or alternator. The electrical machine may include one or more stator assemblies 230 that may surround the over-running shaft core assembly 100 to form the magnetic flux path for the electrical machine 200. For example, each of the stator assemblies 230 may align with a rotor assembly comprising the one or more rotor laminations 130. Additionally, the stator assemblies may be surrounded by a housing 240. The housing 240 may include one or more covers (e.g., cover 220) on an end, where the cover may be concentric with the shaft 110, and may include an opening 260 concentrically aligned with the shaft 110. As discussed above, a portion 210 of the shaft 110 may extend outward from the opening 260 in the cover 220 where an external pully, or other mechanical force transfer system may be mechanically attached. The shaft 110 may be physically affixed and supported in the housing 240 via two or more bearings 250. For example, a first bearing of the bearings 250 may be positioned near an end of the shaft 110 and near a rear portion of the housing 240 and a second bearing of the bearings 250 may be positioned near the opening 260 in the cover 220. In some cases, an inner diameter of the first bearing may be sized to fit the first diameter 112 of the shaft 110 and the second bearing may be sized to fit a second diameter (e.g., the third diameter 116) of the shaft 110. In some cases, the bearings 250 may have the same inner diameter.

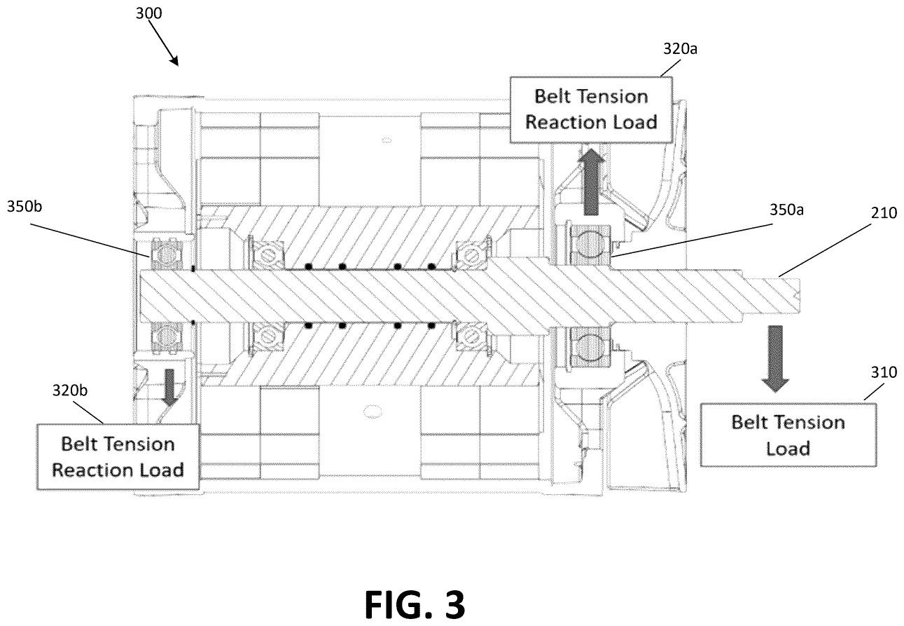

As can be seen in FIG. 3, which shows an illustration of belt tension load exposure 300 to a generator with an integrated over-running shaft core assembly according to aspects of the disclosure. A belt tension load may be applied at the portion 210 of the shaft 110 external to the housing 240. For example, a pully may be mechanically attached to the portion 210 of the shaft, from which a belt may transfer energy from an external rotary potion source (e.g., a powered rotary mechanical transmission). The belt tension may apply a radial load at the end of the shaft that may be compensated in the electrical machine by opposite belt tension reaction loads 320a and 320b at the point of support in the housing, such as at the bearings 350a and 350b.

In an illustrative example of a vehicle alternator, during operation, an external belt drive may apply a positive torque (e.g., the belt tension load 310) to the alternator shaft 110 via a solid pulley or other mechanical connection device (e.g., a chain and/or the like). This positive input torque is transferred to the rotor core 120 via an engaged clutch bearing (e.g., the sprag clutch bearing 140) to allow the core 120 to rotate with the shaft 110 and may be at least partially reduced via static friction provided by a friction element array (e.g., the frictional elements 180). By engaging the shaft 110 to the rotor core 120, the sprag clutch bearing 140 allows the alternator to generate electrical power. The other end of the core is supported by a bearing (e.g., bearing 150). With this arrangement, the entire rotating assembly (e.g., the over-running shaft core assembly 100) will match the speed of the belt drive under steady state torque input. Upon application of negative torque to the shaft, the friction element array will transfer the now negative torque to the core until the static friction threshold (e.g., 10% of the steady-state driving torque, a torque value specified by a particular application, and the like). When the negative torque meets and/or exceeds the static friction threshold, the sprag clutch bearing 140 will disengage and decouple the core 120 from the shaft 110 so that the core 120 may over-run the speed of the shaft via inertia. Immediately upon this decoupling, a combination of windage, dynamic friction from the frictional elements 180, and magnetic drag from the rotor laminations 130 will dissipate the kinetic energy of the core 120 until the core speed matches the now lower speed of the shaft 110 once again. After the negative torque drops beneath the static torque threshold, the sprag clutch bearing 140 engages to engage the core 120 with the shaft to allow the belt drive to drive the core 120 once again to allow the vehicle alternator to generate electrical power.

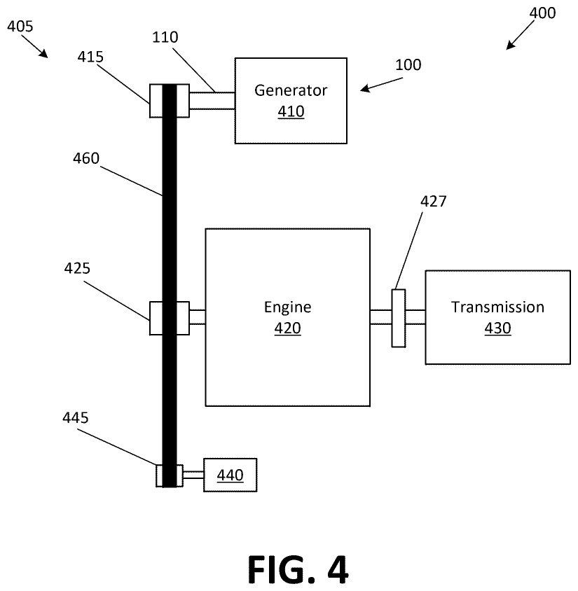

FIG. 4 shows an illustrative block diagram representation of a power generation system 400, such as for a vehicle (e.g., an automobile, a truck, a military vehicle, construction equipment, a boat or ship, an airplane or other flying vehicle, a motorcycle, and/or the like). In the illustrative example, an engine 420, such as an internal combustion engine or the like, may be used to power the vehicle power system and a vehicle propulsion system. In an illustrative example, the vehicle propulsion system may include a clutching mechanism (e.g., a clutch 427) and a transmission 430 to communicate energy produced by the engine 420 to drive one or more propulsion devices (e.g., drive wheels, propellers, track systems, and/or the like).

The engine 420 may also drive a mechanical drive system 405 that may transfer mechanical power from the engine 420 to one or more different vehicle components 440 and an electrical generation device (e.g., the generator 410). The vehicle components may include one or more fluid pumps (e.g., a water pump, a power steering fluid pump, and the like), a fan, a compressor (e.g., an air conditioning compressor), and/or the like. The belt drive system, such as a serpentine belt system, may have multiple components including a belt 460 (e.g., a serpentine belt, a V-belt, and the like), one or more pulleys 415, 425, and 445, along with other components including tensioners, cams, adjusters, and/or the like. In some cases, the mechanical drive system 405 may be a chain drive system, a gear driven system, and/or other mechanical couplings capable of externally driving a rotary electric machine such as the generator 410.

In the simplified block diagram of FIG. 4, a crankshaft of the engine 420 may be physically connected to the pulley 425 to drive the belt 460. The belt 460 may be physically connected to drive the generator 410 via the pulley 415 and each component of the one or more vehicle components 440 via a pulley 445. The pulley 415 may be mounted on the shaft 110 of the generator 410, where the pulley may be a solid pulley. The engine may experience and/or produce torque variations based on the operation of the vehicle, such as accelerations, decelerations, shifting events via the clutch 427 and transmission 430. Such torque variations may be transmitted to the belt 460 via the pulley 425. The over-running shaft core assembly 100 may insulate the generator 410 from these effects, while improving the effective lifetime of the generator 410 for at least the reasons discussed above.

The above-described examples and arrangements are merely some examples of arrangements in which the systems described herein may be used. Various other arrangements employing aspects described herein may be used without departing from the innovative concepts described. It will thus be appreciated that those skilled in the art will be able to devise numerous systems, arrangements, and methods that, although not explicitly shown or described herein, embody the principles of the disclosure and are thus within the spirit and scope of the present disclosure. From the above description and drawings, it will be understood by those of ordinary skill in the art that the particular examples and arrangements shown and described are for purposes of illustrations only and are not intended to limit the scope of the present disclosure. References to details of particular examples and arrangements are not intended to limit the scope of the disclosure.

What is claimed, is:

1. An over-running shaft core assembly for a rotating electrical machine, comprising:
a shaft;
a clutch bearing supporting a portion of the shaft;
a core comprising a through bore centered on an axis of rotation, wherein the through bore comprises a plurality of frictional elements that contact an outer surface of the shaft; and
wherein the frictional elements apply a frictional force to the shaft causing a disengagement delay of the clutch bearing in response to a transient force externally applied to the shaft.

2. The over-running shaft core assembly of claim 1, wherein the plurality of frictional elements are O-rings.

3. The over-running shaft core assembly of claim 1, wherein the shaft freely rotates within the through bore when the clutch bearing is disengaged.

4. The over-running shaft core assembly of claim 1, wherein the transient force is greater than a force to move an inertial mass of the core.

5. The over-running shaft core assembly of claim 1, wherein the core comprises one or more rotor laminations.

6. The over-running shaft core assembly of claim 1, wherein the plurality of frictional elements is distributed along a first portion of the through bore internal to the core.

7. The over-running shaft core assembly of claim 1, further comprising a bearing and wherein a first portion of the through bore is between a first location of the clutch bearing and a second location of the bearing.

8. The over-running shaft core assembly of claim 1, wherein the clutch bearing comprises a sprag clutch bearing.

9. An electrical generator comprising:
a housing surrounding a stator assembly, the stator assembly comprising a cylindrical cavity;
an over-running shaft core assembly, comprising:
a shaft;
a clutch bearing supporting a first portion of the shaft;
a bearing supporting a second portion of the shaft; and
a core comprising a through bore centered on an axis of rotation, wherein the through bore comprises one or more frictional elements, wherein the over-running shaft core assembly is surrounded by the housing and stator assembly in the cylindrical cavity and wherein the one or more frictional elements apply a frictional force to the shaft causing a disengagement delay of the clutch bearing in response to a transient force externally applied to the shaft.

10. The electrical generator of claim 9, wherein the one or more frictional elements are O-rings.

11. The electrical generator of claim 9, wherein the shaft freely rotates within the through bore when the clutch bearing is disengaged.

12. The electrical generator of claim 9, wherein the transient force is greater than a force to move an inertial mass of the core.

13. The electrical generator of claim 9, wherein the core comprises one or more rotor laminations.

14. The electrical generator of claim 9, wherein the one or more frictional elements are distributed along a first portion of the through bore.

15. The electrical generator of claim 9, wherein the first portion of the through bore is between a first location of the clutch bearing and a second location of the bearing.

16. The electrical generator of claim 9, wherein the clutch bearing comprises a sprag clutch bearing.

17. An electrical generation system comprising:
a rotating power transmission system connected to a rotating mechanical energy generation source;
a pully;
a belt driven by the rotating power transmission system to rotate the pulley
an electrical power generation device comprising a shaft, wherein the pulley is physically connected to the shaft, the electrical power generation device comprising;
an over-running core assembly comprising:
a clutch bearing physically connecting the shaft to the over-running core assembly;
a bearing; and
one or more frictional elements physically contacting an outer surface of the shaft, wherein the one or more frictional elements provide a frictional force to the shaft that delays a response by the clutch bearing to transient torque forces applied to the shaft via the belt.

18. The electrical generation system of claim 17, wherein the clutch bearing comprises a sprag clutch bearing.

19. The electrical generation system of claim 17, wherein a frictional force threshold due to the one or more frictional elements is less than or equal to 10% of a steady-state driving torque of an application of the electrical generation system.

20. The electrical generation system of claim 17, wherein the one or more friction elements comprise O-rings.
